(19) United States
(12) Patent Application Publication
(10) Pub. No.: US 2020/0200222 A1
(43) Pub. Date: Jun. 25, 2020

(54) EXTENDED CARTRIDGE SEAL DESIGN FOR BEARING

(71) Applicant: SCHAEFFLER TECHNOLOGIES AG & CO. KG, Herzogenaurach (DE)

(72) Inventors: Rajesh SHANBHAG, Troy, MI (US); Tyler BOGER, Farmington Hills, MI (US)

(73) Assignee: SCHAEFFLER TECHNOLOGIES AG & CO. KG, HERZOGENAURACH (DE)

(21) Appl. No.: 16/225,018

(22) Filed: Dec. 19, 2018

(51) Int. Cl. F16C 33/78

(52) U.S. Cl. CPC F16C 33/7826; F16C 33/783; F16C 33/7859; F16C 2300/42; F16C 2208/12; F16C 2300/02; F16C 2202/08

(57) ABSTRACT

A bearing includes a plurality of rolling elements that contact an inner ring and an outer ring to facilitate relative rotation therebetween. A seal is coupled to one of the rings to inhibit external debris or contaminants from interfering with the rolling operation of the rolling elements. The seal includes a metal insert over-molded with a synthetic material, and wraps around a portion of the ring that it contacts. For example, in one embodiment, the metal insert includes an axially-extending portion extending along at least a portion of the inner surface of the outer ring, and a radially-extending portion extending along at least a portion of the axial face of the outer ring.

### TECHNICAL FIELD

The present disclosure relates to bearings. In particular embodiments, the disclosure relates to a rolling bearing having a seal with a structural insert that wraps around at least a portion of one of the rings of the bearing.

### BACKGROUND

Bearings are used in a wide range of applications, and come in a variety of forms. One type of bearing is a rolling bearing. Rolling bearings typically have an inner raceway, and outer raceway, and a plurality of rolling elements between the rings that enable rotational movement between the rings.

Rolling bearings may also include a seal between the inner ring and the outer ring. The seal works to inhibit external fluids, contaminants, or debris from entering the raceways and interfering with the engagement between the rolling elements and the raceways. Particularly for parts of the bearing that perform little to no relative rotational movement during operation, corrosion should be accounted for by preventing liquids from becoming entrapped in the bearing.

### SUMMARY

According to one embodiment, a bearing includes an inner ring extending about an axis, and an outer ring extending about the axis that defines an inner surface facing the axis and an axial face facing a direction parallel to the axis. A plurality of rolling elements contact the inner ring and the outer ring to facilitate relative rotation therebetween. A flinger has an axially-extending surface coupled to the inner ring via an interference fit, and a radially-extending surface extending partially toward the outer ring. The flinger is configured to rotate with the inner ring to redirect external fluid or debris away from the rolling elements. A seal is coupled to the outer ring via an interference fit and is coupled to the flinger wherein, the seal includes a metal insert over-molded with a synthetic material. The metal insert includes an axially-extending portion extending along at least a portion of the inner surface of the outer ring, and a radially-extending portion extending along at least a portion of the axial face of the outer ring.

According to another embodiment, a bearing comprises an inner ring, an outer ring, and a seal. The inner ring has an inner surface and an axial face. The inner ring is rotatable relative to the outer ring via a plurality of rolling elements disposed therebetween. The seal is disposed radially between the inner ring and the outer ring, and includes an insert at least partially embedded in a synthetic material. The insert has an axially-extending portion at least partially covering the inner surface of the inner ring. The insert has a radially-extending portion at least partially covering the axial face of the inner ring.

In yet another embodiment, a bearing includes a first ring defining a first raceway, the first ring including an axially-extending surface and a radially-extending surface intersecting at a corner. A second ring defines a second raceway. An array of rolling elements is disposed in the first and second raceways to enable relative rotation between the first ring and the second ring. A seal includes a structural insert over-molded with a synthetic material. The structural insert extends out of the synthetic material and wraps around the corner of the first ring.

### BRIEF DESCRIPTION OF THE DRAWINGS

FIG. 1 is a cross-sectional view of a bearing according to one embodiment.

FIG. 2 is a cross-sectional view of a region of the bearing of FIG. 1 as indicated in FIG. 1, according to one embodiment.

FIG. 3 is a cross-sectional view of a similar region of another bearing according to a second embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Directional terms used herein should be understood to be referring to the orientation of the structure depicted in the figures. If an object is said to be extending about an axis, then terms such as “radial” and “axial” are relative to the axis. For example, the “axial” direction is one along or parallel to a center axis, and the “radial” direction is normal to the axial direction. An “axial” surface is a surface extending at least partially in the radial direction but located at a particular axial point along the axis. Likewise, a “radial” surface is a surface extending at least partially in the axial direction but located at a particular radial distance from the axis. “Inner” and “outer” also are relative to the axis; for example, an “inner surface” may be a surface facing the axis, and an “outer surface” may be a surface facing away from the axis. These terms can be used as explained above unless otherwise noted.

Rolling bearings may also include a seal between the inner ring and the outer ring. The seal works to inhibit external fluids, contaminants, or debris from entering the raceways and interfering with the engagement between the rolling elements and the raceways. Particularly for parts of the bearing that perform little to no rotational movement during operation, corrosion should be accounted for by prevent liquids from becoming entrapped in the bearing.

For example, one type of rolling bearing may be situated under the chassis and support the prop shaft in an automotive vehicle. This location on the vehicle may subject the bearing to a large amount of splashing of external liquid and debris. Also, this type of bearing may have an outer ring that remains relatively stationary while the inner ring rotates. This may create an environment where the external liquid and debris can pool and become trapped between the non- rotating outer ring and the housing or seal of the bearing. For example, if unaccounted for, the pooling can cause corrosion of the seal seat, which can expose the bearing interior to contamination. The static seal seat can initiate corrosion and let the contamination enter the bearing interior.

The bearing of the present disclosure aims to prevent or reduce such contaminations from causing potential corrosion. Various embodiments are disclosed below. In short, a seal is placed between the inner and outer rings of the bearing. The seal has an insert integrated with the seal (e.g., via over-molding). The insert itself wraps around at least a portion of one of the rings to inhibit the external fluid or contaminants from entering the interior of the bearing.

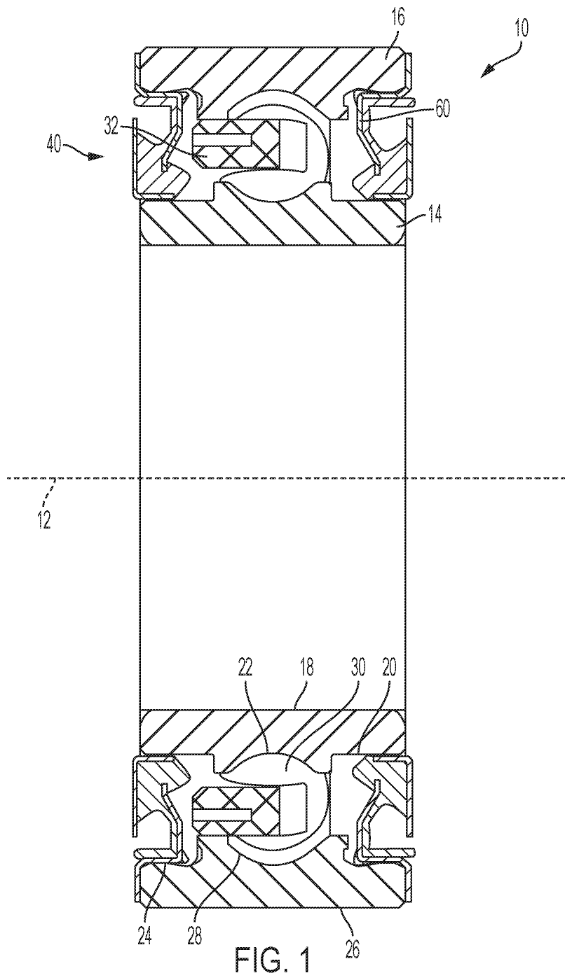

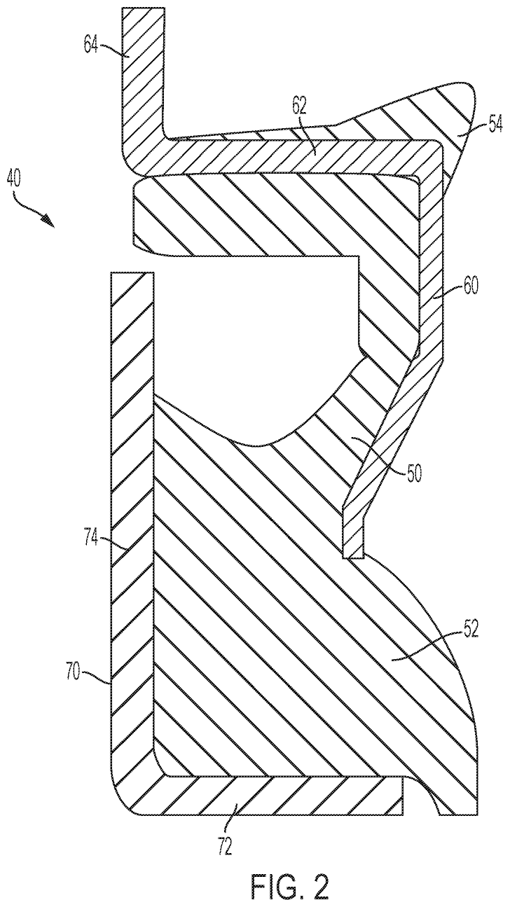

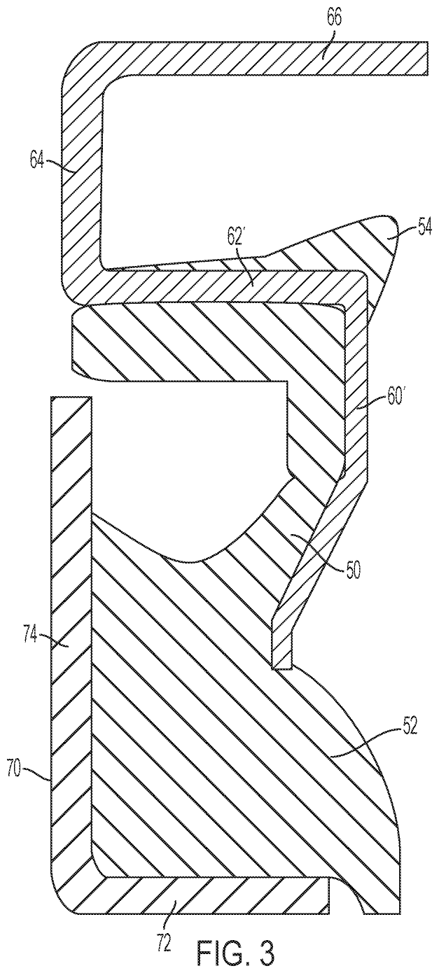

FIGS. 1-2 show a first embodiment of such a bearing, with FIG. 1 showing a cross-sectional view of the bearing and FIG. 2 showing a region of FIG. 1 enlarged for clarity. FIG. 3 shows a second embodiment from a similar view of FIG. 2, in which the insert is extended to further wrap around more portions of the bearing.

Referring to the embodiment of FIGS. 1-2, a bearing 10 is illustrated. The bearing 10 may be a rolling bearing situated under a chassis of a vehicle as explained above, but may be used in numerous other applications.

The bearing 10 has several components that extend annularly about a central axis 12. For example, the bearing 10 of this embodiment has an inner ring 14 and an outer ring 16. Either or both of the inner ring 14 and the outer ring 16 may rotate about the central axis and relative to one another. The inner ring 14 may define an inner surface 18 that faces the axis 12 and an outer surface 20 that faces away from the axis 12. The outer surface 20 defines an inner raceway 22. Likewise, the outer ring 16 may define an inner surface 24 that faces the axis 12 and an outer surface 26 that faces away from the axis 12. The inner surface 24 defines an outer raceway 28.

A plurality of rolling elements 30 are provided and contact the inner raceway 22 and the outer raceway 28. The rolling elements 30 can rotate between the raceways, thereby facilitating relative rotation between the inner ring 14 and the outer ring 16 about the axis 12. The rolling elements 30 may be spherical rollers, but may also by cylindrical or other suitable shapes. A cage 32 may be provided to maintain separation between the rolling elements 30 and contain the rolling elements in an annular array about the axis 12.

A seal 40 is provided between the inner ring 14 and the outer ring 16. The seal 40 is configured to inhibit external fluids, contaminants, or debris from entering an interior region of the bearing 10 and interfering with the rotation of the rolling elements 30 within the raceways 22, 28. A seal 40 may be provided on each axial side of the bearing, as shown in FIG. 1. Each seal 40 may be generally annular in shape, extending about the axis 12.

A portion of one of the seals 40 is illustrated in FIG. 2. The seal 40 may include the following three components: a sealing body 50, a structural insert 60, and a flinger 70.

The sealing body 50 may be a synthetic material and may include a polymer, a rubber such as a thermoplastic elastomer (TPE), a thermoplastic polyurethane (TPU), or other material suitable for a dynamic seal. The material chosen should be one that can be molded and co-molded or over-molded with another material, such as metal. The material chosen should also be able to rotatably contact a metal object (such as the flinger 70 described below) without losing durability or effectiveness.

The sealing body 50 can take any shape suitable to seal off the interior of the bearing (e.g., the raceways and rolling elements) from the exterior of the bearing. The profile of the sealing body 50 shown in FIGS. 1-3 is merely exemplary. In other examples, the sealing body has various lips that extend to make smaller points of contact with the flinger 70, the inner ring 14 or the outer ring 16. In one embodiment, the sealing body 50 includes an inner sealing body 52 contacting the inner ring 14, and an outer sealing body 54 contacting the outer ring 16. The inner sealing body 52 may create a dynamic seal with the inner ring 14 due to the relative rotation between the inner sealing body 52 and the inner ring 14. The outer sealing body 54 may create a static seal due to the lack of relative location between the outer sealing body 54 and the outer ring 16.

In one embodiment, the structural insert 60 is over-molded with the synthetic material of the sealing body 50. For example, the structural insert 60 may be bent to shape and then placed in a mold. Thereafter, the synthetic material in liquid form can be inserted into the mold and over the structural insert 60. Once hardened, this provides a fused or bonded connection between the structural insert 60 and the sealing body 50 via an over-mold. It may therefore be said that the structural insert 60 is at least partially embedded in the synthetic material of the sealing body, with over-molding being one such application to accomplish the embedding. As such, the structural insert 60 may be made of metal, such as steel. This provides improved rigidity for the seal.

As explained above, the seal 40 is provided with an integrated structural insert 60 that wraps around at least a portion of one of the rings to inhibit or delay corrosion of the rings due to the potential of external fluid or contaminants from entering the interior of the bearing. In one embodiment, the structural insert 60 includes an axially-extending portion 62. This portion 62 may be over-molded with the synthetic material of the outer sealing body 54 such that the outer sealing body 54 directly contacts the inner surface 24 of the outer ring 16. In other embodiments not illustrated herein, the axially-extending portion 62 may have an outer surface that directly contacts the inner surface 24 of the outer ring 16.

The structural insert 60 includes a radially-extending portion 64 extending radially outwardly from the axially-extending portion 62. As shown in the embodiment illustrated in FIGS. 1-2, the radially-extending portion 64 may extend out from the synthetic material of the outer sealing body 52. In other words, in some embodiments the radially-extending portion 64 is not embedded in or otherwise bonded with the outer sealing body 54. It may therefore be said that the radially-extending portion 64 is a tang or flange that protrudes out from the synthetic material of the sealing body 50. In other embodiments, the radially-extending portion 64 is also over-molded or otherwise embedded or bonded with the outer sealing body 54.

The radially-extending portion 64 may directly contact and overlap a portion of the outer ring 16. In particular, the radially-extending portion may have an axial surface that directly contacts a corresponding axial face of the outer ring. Due to the interference fit between the seal 40 and the outer ring 16, the direct contact between the structural insert 60 and the outer ring 16 may not create significant wear on the structural insert. Utilizing a continuous structural insert 60 that wraps around an interior edge or corner of the outer ring 16 in this fashion inhibits external fluid or debris from entering the space between the synthetic material of the outer sealing body 51 and the inner surface 24 of the outer ring 16.

To even further inhibit external fluid or debris from entering the interior of the bearing, the structural insert may be further extended to wrap around a larger section of the outer ring 16. FIG. 3 illustrates such an embodiment. The structural insert 60′ includes a axially-extending portion 62′ and a radially-extending portion 64′ similar to the structural insert of 60 in FIG. 2. In this embodiment, the structural insert 60′ includes a second axially-extending portion 66. The second axially-extending portion 66 extends from the radially-extending portion 64′ and wraps around the outer ring 16 to at least partially overlap with the outer surface 26 of the outer ring 16.

As mentioned, a flinger 70 is provided. The flinger 70 has such a name because during rotation of the bearing the flinger can “fling” or sling external liquids and/or debris away from the bearing 10. The flinger 70 can be press-fit to provide a connection with the inner ring 14 via an interference fit. As such, as the inner ring 14 rotates about the axis 12, the flinger 70 also rotates with the inner ring 14. A rotational speed of the flinger 70 allows the flinger to fling the external liquids and/or debris away from the bearing 10 as the flinger 70 spins.

The flinger 70 can be attached to the inner ring 14 after the attachment of the seal 40 to the bearing 10. This may create a single unit, comprising the flinger 70, the sealing body 50, and the structural insert 60. The flinger 70 may be connected (e.g., via interference fit) to the inner ring 14 while the seal 40 may be connected (e.g., via interference fit) to the outer ring 16. Therefore, relative movement between the flinger 70 and the outer ring 16 may be realized during operation of the bearing 10. A tight seal should be provided between the flinger 70 and the inner sealing body 52 to inhibit fluid from entering the interior of the bearing while still enabling relative rotation between the flinger 70 and the inner sealing body 52.

In one embodiment, the flinger 70 is metal (e.g., steel), but can also be a synthetic material with a material hardness that exceeds that of the sealing body 50.

The flinger 70 may have an axially-extending portion 72 that directly contacts the outer surface 20 of the inner ring 14. The flinger 70 may also have a radially-extending portion 74 that extends radially toward the outer ring 16. While the radially-extending portion 74 is shown to only partially extend toward the outer ring 16, in other embodiments the radially-extending portion 74 extends further radially outwardly such that it axially overlaps with at least a portion of an axial face of the outer ring 16.

It should be understood that references to the “seal” as explained above can refer to a combination of the synthetic material and the structural insert 60, 60′. Alternatively, the term “seal” can refer to the synthetic material, the structural insert, as well as the flinger 70. In other words, the flinger may be part of the seal or may be a separate element separately attached to the seal.

The embodiments described above and illustrated in the figures are only an example of certain configurations. In other embodiments and implementations of the bearing, the inner ring 14 can remain relatively stationary while the outer ring 16 rotates. The flinger can be non-rotatably attached (e.g., via an interference fit) to the outer ring 16 rather than the inner ring 14. Also, in such an embodiment the structural insert 60 can wrap at least partially around the inner ring 14 rather than the outer ring 16.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

### Parts List

The following is a list of reference numbers shown in the Figures. However, it should be understood that the use of these terms is for illustrative purposes only with respect to one embodiment. And, use of reference numbers correlating a certain term that is both illustrated in the Figures and present in the claims is not intended to limit the claims to only cover the illustrated embodiment.

10 bearing

12 axis

14 inner ring

16 outer ring

18 inner surface of inner ring

20 outer surface of inner ring

22 inner raceway

24 inner surface of outer ring

26 outer surface of outer ring

28 outer raceway

30 rolling elements

32 cage

40 seal

50 sealing body

52 inner sealing body

54 outer sealing body

60 structural insert

60′ structural insert

62 axially-extending portion

62′ axially-extending portion

64 radially-extending portion

64′ radially-extending portion

66 second axially-extending portion

70 flinger

72 axially-extending portion

74 radially-extending portion

What is claimed is:

1. A bearing comprising:
an inner ring extending about an axis;
an outer ring extending about the axis and defining an inner surface facing the axis and an axial face facing a direction parallel to the axis;
a plurality of rolling elements contacting the inner ring and the outer ring to facilitate relative rotation therebetween;
a flinger having an axially-extending surface coupled to the inner ring via an interference fit, and a radially-extending surface extending partially toward the outer ring, wherein the flinger is configured to rotate with the inner ring to redirect external fluid or debris away from the rolling elements; and
a seal coupled to the outer ring via an interference fit and coupled to the flinger, the seal including a metal insert over-molded with a synthetic material, wherein the metal insert includes:
an axially-extending portion extending along at least a portion of the inner surface of the outer ring, and
a radially-extending portion extending along at least a portion of the axial face of the outer ring.

2. The bearing of claim 1, wherein the metal insert extends out of the synthetic material.

3. The bearing of claim 2, wherein the axially-extending portion includes an outer surface directly contacting the inner surface of the outer ring.

4. The bearing of claim 2, wherein the radially-extending portion includes a surface directly contacting the axial face of the outer ring.

5. The bearing of claim 1, wherein the metal insert is a single annular member extending continuously from the axially-extending portion through the radially-extending portion.

6. The bearing of claim 1, wherein the flinger directly contacts the inner ring, the metal insert contacts the outer ring either directly or indirectly via rubber, and the seal is located radially between the flinger and the metal insert.

7. A bearing comprising:
an inner ring having an inner surface and an axial face;
an outer ring, wherein the inner ring is rotatable relative to the outer ring via a plurality of rolling elements disposed therebetween; and
a seal disposed radially between the inner ring and the outer ring, the seal including an insert at least partially embedded in a synthetic material, wherein the insert has an axially-extending portion at least partially covering the inner surface of the inner ring, and the insert has a radially-extending portion at least partially covering the axial face of the inner ring.

8. The bearing of claim 7, wherein a portion of the insert extends out from the synthetic material such that the portion is not embedded in the synthetic material.

9. The bearing of claim 8, wherein the radially-extending portion is not embedded in the synthetic material and directly contacts the axial face of the outer ring.

10. The bearing of claim 7, wherein the insert includes a second axially-extending portion covering at least a portion of an outer surface of the outer ring.

11. The bearing of claim 10, wherein the insert wraps around at least a portion of the outer ring from the inner surface of the outer ring to the outer surface of the outer ring.

12. The bearing of claim 7, wherein the insert is metal.

13. The bearing of claim 7, further comprising a flinger coupled to the inner ring via an interference fit, wherein the flinger and inner ring rotate relative to the seal.

14. A bearing comprising:
a first ring defining a first raceway, the first ring including an axially-extending surface and a radially-extending surface intersecting at a corner;
a second ring defining a second raceway;
an array of rolling elements disposed in the first and second raceways to enable relative rotation between the first ring and the second ring; and
a seal including a structural insert over-molded with a synthetic material, wherein the structural insert extends out of the synthetic material and wraps around the corner of the first ring.

15. The bearing of claim 14, wherein the first ring is an outer ring and the second ring is an inner ring.

16. The bearing of claim 14, further comprising a flinger coupled to the first ring via an interference fit, the flinger having a radially-extending surface extending at least partially toward the second ring, wherein the radially-extending surface extends axially beyond the first and second rings.

17. The bearing of claim 16, wherein the seal is coupled to the second ring via an interference fit and contacts the flinger such that the seal rotates relative to the flinger.

18. The bearing of claim 14, wherein the structural insert includes an axially-extending portion directly contacting the axially-extending surface of the first ring, and the structural insert includes a radially-extending portion directly contacting the radially-extending surface of the first ring.

19. The bearing of claim 14, wherein the axially-extending surface is a first axially-extending surface, and wherein the first ring includes a second axially-extending surface spaced from the first axially-extending surface by the radially-extending surface, wherein the structural insert directly contacts the first axially-extending surface, the radially-extending surface, and the second axially-extending surface.

20. The bearing of claim 14, wherein the structural insert is metal and the synthetic material is rubber.
